(19) United States
(12) Patent Application Publication
(10) Pub. No.: US 2005/0079247 A1
(43) Pub. Date: Apr. 14, 2005

(54) Food composition and method of making same

(76) Inventor: George E. Slilaty, Binghamton, NY (US)

Correspondence Address: Lawrence R. Fraley, IP Law Counsel;FBU/257-4 AA14, 1701 North Street, Endicott, NY, 13760, US

(21) Appl. No.: 10/683,378

(22) Filed: Oct. 14, 2003

(51) Int. Cl. A23G 3/00

(52) U.S. Cl. 426/94

(57) ABSTRACT

A food composition and method of making same wherein the composition includes a base not primarily of flour and sugar, and a supplement. The composition is functional as a substitute for traditional flour and sugar food products to mimic the organeoleptic properties of such traditional food products to thus provide the consumer with a product that is both tasty and pleasant in smell while simultaneously affording the consumer with a properly nutritious product to meet needed dietary requirements for a healthy lifestyle. Examples include muffins, doughnuts, pastas, pancakes and waffles, to name a few. A method of making this food composition is also provided.

### TECHNICAL FIELD

This invention relates to food compositions and methods of making same and particularly to food compositions designed primarily for human consumption which provide the consumer with proper daily nutritional requirements.

### BACKGROUND OF THE INVENTION

Various food compositions, ranging from those designed to help with human reproduction to those having specified textures, and methods of producing same are described in the following publications:

U.S. LETTERS PATENTS

| | | |
|---|---|---|
| 3,697,287 | Winitz | 10/72 |
| 4,119,734 | Spiel | 10/78 |
| 4,208,433 | Barham, et al | 06/80 |
| 4,764,388 | Sullivan et al | 08/88 |
| 5,242,697 | Lucá | 09/93 |
| 5,536,522 | Seeds et al | 07/96 |
| 5,578,336 | Monte | 11/96 |
| 5,834,044 | Schmitz et al | 11/98 |
| 6,039,978 | Bangs et al | 03/00 |
| 6,039,989 | Bangs et al | 03/00 |
| 6,103,283 | Zukerman et al | 08/00 |
| 6,210,720 B1 | Leusner et al | 04/01 |
| 6,482,430 B1 | Weightman et al | 11/02 |
| 6,493,641 B1 | Singh et al | 12/02 |
| 6,558,718 B1 | Evenson et al | 05/03 |
| 6,569,483 B2 | Zohoungbogbo | 05/03 |
| 5,562,384 B1 | Bavone | 05/03 |
| 6,569,857 B1 | Hermelin et al | 05/03 |
| 6,576,666 B2 | Hermelin et al | 06/03 |
| 6,579,555 B1 | Weinstein et al | 06/03 |
| 6,583,271 B1 | Buchanan et al | 06/03 |

PUBLISHED U.S. PATENT APPLICATIONS

| | | |
|---|---|---|
| 2002/0004749 A1 | Froseth et al | 01/02 |
| 2002/0193617 A1 | Ulrich et al | 12/02 |

In addition to the above, the published U.S. patent application 2002/0004749, published Jan. 10, 2002, even describes a computerized program for selecting, ordering and distributing food products.

As is known, a complete (proper) nutritional diet for human consumption requires the daily ingestion of proteins, vitamins, minerals, fats and, of course, a source of calories which are typically in the form of carbohydrates. Such constituents are of course available in various natural food sources such as meat, fruits, and vegetables.

Proteins, being of high molecular weight and complex polymers, are composed of a variety of essential and nonessential amino acids. Proteins are broken down (degraded) by the proteolytic enzymes in the human consumer's gastrointestinal tract to form these acids, which are then absorbed through the tract. A usual source of carbohydrates for human consumers are in the form of starches, which are high molecular weight, water-insoluble polymers of glucose. Other sources include lactose, sucrose and fructose. Carbohydrates, the source of calories, are thus utilized in the human consumer as a prime source of energy. Enzymatic action in the gastrointestinal tract degrades the polymer or dimeric forms of these into the necessary monomer form such that these too are then absorbed through the tract for human benefit. Lipids usually appear in a normal diet regime as fats and oils in the form of triglycerides of three molecules of fatty acids in combination with one molecule of glycerol. Common fatty acids include stearic, oleic, palmitic, linoleic, myristic and arachidonic acids. Degradation of those fatty acids found to be essential for human consumption is accomplished through enzymatic action of the lipases of the tract, from which free fatty acids are formed. Fats, like carbohydrates, serve to provide the human consumer with a source of energy.

Mineral sources for humans include ions of sodium, potassium, calcium, magnesium, and chloride in relatively larger quantities compared to ions of iron, manganese, cobalt, copper, molybdenum, zinc and iodide in relatively lesser amounts. Minerals are typically provided in the normal diet in a dissociated form such as sodium chloride as both the sodium and chloride ions, but may appear in a covalent combination with organic molecules such as cobalt in vitamin B-12. Finally, vitamins occur in natural dietary regimens either in free form or combined with other chemical moieties. Water-soluble vitamins include ascorbic acid, thiamine, riboflavin, biotin, and, of course, vitamins A, D, B-6 and B-12.

Unfortunately, due to today's relatively high paced and often hectic style of life, many people are simply unable or elect not to partake of the proper nutritional foods necessary to sustain a proper daily diet. It has become more convenient to grab a bowl of cereal or a donut and coffee in the morning or other times rather than sit down and take the time for a good, well planned meal. And, as is well known, typical “quick” products such as donuts, muffins and most cereals consist of relatively large percentages of flour and sugars, considered by many medical and dieticians as deleterious to the consumer because of such large percentages and the lack of needed nutrients therein. Other “quick” products such as hamburgers and cheeseburgers and accompanying items typically available in many of today's “fast food” restaurants contain what some have stated are inappropriately high levels of fats and other undesirable elements for a healthy lifestyle, if maintained over a relatively long period of time.

As a result of the above and other factors, many of today's consumers are becoming obese at an increasing and alarming rate, and are also incurring other diseases associated with improper dietary intake, a prime example being diabetes.

To further complicate matters for one seeking a proper dietary intake, there are several “diet plans” being offered today which provide often conflicting information to the consumer not completely knowledgeable in dietary needs. Two examples include the well known “Atkins diet” strongly emphasizing protein consumption, and the “Mediterranean diet”, based on foods rich in complex carbohydrates such as pasta, rice, bread and the like. Accordingly, even for many who desire to participate in a proper, well balanced dietary intake, it has become increasingly confusing what is the best way to accomplish this.

The present invention, as defined in greater detail herein below, represents a new and unique solution to providing a food product which will be both tasty and nutritious, while assuring the proper sources of the above needed constituents, yet which minimizes undesirable elements inappropriate for a proper healthy diet. It also assures that such consumers will be subjected to elements which, if taken in proper quantities, will meet today's dietary standards such as those defined by the U.S. Department of Health for human consumption. That is, if taken in proper quantities, the food compositions (products) defined herein will provide the consumer with a balanced diet of the necessary elements for a healthy lifestyle, thus helping to substantially prevent such diseases as diabetes and especially obesity (thus assisting individual consumers in preventing the occurrence of cardiovascular and metabolic diseases such as arteriosclerosis, heart disease, type II diabetes, etc. associated with such obesity). Significantly, the food compositions as defined herein are readily adaptable to a variety of different dietary constraints such as those imposed on many persons today, e.g., low fat and similar diets, that physicians and/or dieticians require of their patients with various medical problems or who presently appear susceptible to same in the opinions of such physicians and/or dieticians.

It is believed that such a food composition and a method of making same would constitute significant advancements in the art.

### OBJECTS AND SUMMARY OF THE INVENTION

It is, therefore, a primary object of the present invention to enhance the food composition field.

It is another object of the invention to provide a safe, nutritious food product which is appealing to the consumer in terms of both taste, texture and smell.

It is still another object of the invention to provide such a food product which is affordable and thus priced competitively with competing food products of the type mentioned above, e.g., conventional donuts and muffins.

It is yet another object of the invention to provide a method of making such a food product which can be implemented in a facile manner and at relatively little cost.

According to one aspect of the invention, there is provided a food composition comprising a base not primarily of flour and sugar, and a supplement, the food composition being a substitute for traditional flour and sugar-based food compositions and substantially mimicking the organeoleptic properties of the traditional flour and sugar-based food compositions.

According to another aspect of the invention, there is provided a method of making a food composition, the method comprising the steps of providing a base not primarily of flour and sugar, providing a supplement, and combining the base and supplement, the food composition being a substitute for traditional flour and sugar-based food compositions and substantially mimicking the organeoleptic properties of the traditional flour and sugar-based food compositions.

According to yet another aspect of the invention, there is provided a base food product not primarily of flour adapted for being combined with a supplement to form a food composition, the food composition adapted for substituting for traditional flour and sugar-based food compositions and substantially mimicking the organeoleptic properties of the traditional flour and sugar-based food compositions.

### BEST MODE FOR CARRYING OUT THE INVENTION

For a better understanding of the present invention, together with other and further objects, advantages and capabilities thereof, reference is made to the following disclosure and appended claims.

By the term “base” as used herein is meant the primary component of an eventual food composition which serves as the primary source for many of the essential nutrients needed by a human being who consumes such an eventual food composition.

By the term “not primarily flour and sugar” as used herein is meant a base in which the flour and sugar content is less than about 40% by weight and preferably less than about 20% by weight.

By the term “supplement” as used herein is meant an additional component of an eventual food composition which provides the remainder of the nutrients essential for a balanced diet needed by a human being who consumes such an eventual food composition.

By the term “traditional” as used herein is meant conventional food products presently available on the market today in which at least part thereof, typically the base as defined herein, is comprised of a percentage of flour and sugars greater than about 50% by weight and typically greater than about 80% to about 90% by weight of flour and sugar constituents.

By the term “organeoleptic” as used herein is meant to include properties which affect the sense organs of human beings, primarily taste and odor.

By the term “mimic” as used herein is meant to imitate very closely to the average human being consumer of food compositions such as defined herein.

The terms “bread”, “pasta”, “baked good”, “dough”, and “baking mix” as used herein are meant to have their conventional meanings as they apply to the edible food product environment, except to the extent these are modified as taught herein so as to substantially not include the undesirable elements as part thereof in the quantities found in most of today's known such products.

The food compositions of the instant invention can be used to provide balanced proper nutrition for all age groups (development and sustaining) and can be readily adapted to meet any of several nutritional lifestyles, including as examples those requiring controlled carbohydrates (e.g., for weight control and diabetes prevention), those requiring high proteins (e.g., building muscle mass), those requiring controlled fat intake (e.g., weight control and heart disease prevention) wherein no hydrogenated fats are allowed, those to satisfy Kosher and other religious dietary requirements, those designed to meet other tolerances such as gluten and lactose, and those requiring organic food intake (e.g., disease prevention and allergen reduction), to name a few.

According to one aspect of the invention, there is provided a food composition which comprises a base not primarily of flour and sugar and a supplement. Significantly, the food compositions defined herein serve as a substitute for traditional flour and sugar-based food compositions and substantially mimic the organeoleptic properties of such traditional flour and sugar-based food compositions. That is, the food products as defined herein provide substantially similar taste and smell properties as traditional food products which these are designed to mimic to thus be attractive to the human consumer while, significantly, providing the consumer with the necessary nutritional requirements of the proper (selected) diet. As stated above, each of the food compositions defined herein can be adjusted, percentage-wise, to include a various range of such nutritious elements, depending on the dietary lifestyle chosen by the consumer. Examples of such lifestyles are described above. For example, the food compositions taught herein can possess a relatively high percentage of protein to meet the requirements of those presently using the “Atkins diet”. In all instances, however, the base components of the food compositions as defined herein are not primarily of flour or sugar, as is typically found in many food products, e.g., donuts, muffins, pancakes, waffles, cereals, pastas, and snacks found on the market today. The food compositions taught herein may be in the form of such products, but instead possess the necessary nutrients as illustrated by the following examples taught herein.

The food compositions including the base and supplement components may be in the form of various food products, including ready-to-eat (RTE) cereals and snacks, baking mixes, baked good products (e.g., breads) or such other widely desired products as biscuits, muffins, donuts, cookies, pancakes and waffles. The food compositions taught herein may also be in the form of a dough material which can then be utilized to form a final food product, e.g., by baking. Also, the food compositions as mentioned above, can be in the form of a pasta product such as spaghetti, rigatoni, etc., several of which are presently known on the market today but which do not contain the nutritious benefits to the level taught herein.

As stated, the base component for the invention is not primarily of flour and sugar. By this is meant that the base will contain less than 40% by weight of flour and sugar constituents. In preferred examples of the invention, the food compositions possess less than 20% by weight of flour and sugar, and may be as low as from about 5% to about 10% by weight, while still providing the mimicking functions described herein.

Examples of such base components include plant and grain proteins, grain fibers, grain brans, grain carbohydrates, isolates, and mixtures thereof. By the term grain protein is meant the protein content of the grain being extracted by processing or isolating.

Another base component may include milk or milk derivative proteins. If these are used, a preferred percentage of same in the final food composition will range from about 1% to about 10%.

Another base component may include egg or egg derivatives. If these are used, a preferred percentage of same in the final food composition will range from about 1% to about 10%.

Another form of a base component is sweeteners and sugars or sugar substitutes, a desired end food product using such a base including fructose, sucrose, dextrose, honey, molasses, etc.

It is also within the scope of the invention to utilize some fats as the base component, examples of desired food products in which such fats will form a base including oils derived from nuts or vegetables and also animal-based fats.

In yet another embodiment of the invention, the base may comprise at least one leavening system and at least one salt, preferably within a range of 1% to about 7% by weight of the total food composition. Desired food products in which such a base will be used include chemical leavening bases (e.g., bicarbonates), acids (e.g., phosphates), as well as yeast.

With regard to supplements for use with the food composition taught herein, examples of such supplements include vitamins, minerals, amino acids, nutraceuticals, special nutrients and mixtures thereof. In one example wherein the supplement includes a vitamin, the vitamin may be Ascorbic Acid, Beta-carotene, Biotin, Choline, Folic Acid, Inositol, Niacin, Pantothenic Acid (Vitamin B5), Phylloquinone (Vitamin K), Pyridoxine (Vitamin B6), Riboflavin (Vitamin B2), Thiamin (Vitamin B1), Vitamin A, Vitamin B12, Vitamin D, Vitamin E and mixtures thereof.

If the food composition of the invention includes a mineral supplement, the mineral is preferably Boron, Calcium, Chloride, Chromium, Chromium III, Copper, Fluoride, Iodine, Iron, Magnesium, Manganese, Molybdenum, Phosphorus, Potassium, Selenium, Silicon, Sodium, Sulfur, Vanadium, Zinc and mixtures thereof.

Should the supplement be an amino acid, such amino acids include Alanine, Arginine, Aspartic Acid, Asparagine, Carnitine, Cysteine, Cystine, Glutamic Acid, Glutamine, Glutathione, Glycine, Histidine, Isoleucine, Leucine, Lysine, Methionine, Ornithine, Phenylalanine, Proline, Serine, Taurine, Threonine, Tryptophan, Tyrosine, Valine and mixtures thereof.

Should a nutraceutical supplement be utilized, the nutraceutical may be comprised of Aloe Vera (Aloe ferox, A. barbadensis), Artichoke, Asian Ginseng (Panax ginseng), Astragalus, Bee Pollen, Bilberry (Vaccinium myrtillus), Black Cohosh, Capsicum-Cayenne, Hot Pepper (Capsicum species), Cascara Sagrada (Rhamnus purshiana), Cat's Claw (Uncaria tomentosa), Chamomile (Matricaria recutita), Cranberry, Dandelion (Taraxacum officinale), Donq Quai (Angelica sinensis), Echinacea (Echinacea purpurea and related species), Evening Primrose Oil (Oenothera biennis), Feverfew (Tanacetum parthenium), Fructo-oligosaccharides, Garlic (Allium sativum), Ginger (Zingiber officinale), Ginkgo (Ginkgo biloba), Ginseng, Glucarate, Glucosamine, Goldenseal (Hydrastis canadensis), Gotu Kola (Centella Asiatica), Grape Seed Extract, Green Tea, Guarana (Paullinacupana), Hawthorne (Crataegus oxyacantha), Inulin, Isoflavones, Kava Kava (Piper methysticum), L-carnitine, Lecithin, Licorice (Glycyrrhiza glabra and G. uralensis), Lycopene, Milk Thistle (Silybum marianum), Mod. Citrus Peel, Nettles, Oligofructose, Omega-3s, Passiflora, Passion Flower (Passiflora incarnata), Pau d'Arco, (Tabebuia impetiginosa), Peppermint (Mentha piperita), Phospholipids, Polyphenol, Psyllium (Plantago ovata and P. Major), Pycnogenol, Queroetin D-llmonene, Reishi, Ribonucleic Acid, Royal Jelly, St. John's Wort (Hypericum perforatum), Saw Palmetto (Serenoa repens; Sabal serrulata), Schisandra, Soybean Isoflavones, Tumeric Valerian (Valeriana officinalis) and mixtures thereof.

If the food composition utilizes a special nutrient as a supplement, examples of such a special nutrient may include Acetyl Glucosamine, Acetyl-L-Carnitine, Alpha-Ketoglutaric Acid, Alpha Lipoic Acid, Androstenedione, Arginine Pyroglutamate Arthred, Co-Enzyme Q-10, Creatine Monohydrate, DHEA (dehydroepiandrosterone), DMAE (dimethylaminoethanol), DMG (dimethylglycine), Gamma Oryzanol, Glucosamine Sulfate, Lutein, Melatonin, N-Acetyl Cysteine, PABA, Phosphatidylcholine, Pregnenolone, Pyruvate, Quercetin, Sano-Gastirl, Seriphos, Stabilium, Tricycline, Trifal and mixtures thereof.

It is understood that the invention is not limited to a particular one of the above bases (e.g., grain fiber) in combination with a particular supplement, e.g., the nutraceutical ginger. Instead, the invention is capable of utilizing a multitude of variations of such combinations of base and supplement components, depending on the nutritional lifestyle of the eventual human consumer. These food compositions can thus be varied to meet a variety of such lifestyles and thus in various percentages by weight to do so. As stated, however, it is particularly important that the base component not be comprised primarily of flour and sugar; that is, it cannot be comprised of greater than 50% by weight of flour and sugars. As stated above, many of traditional food products currently available today possess as much as 80 to 90% by weight of such flour and sugar constituents, deemed unacceptable by many dieticians and physicians.

The following are examples of various food compositions, broken down by element and weight percentage thereof, to form the defined food product:

| | |
|---|---|
| Component | Percentage by Weight |

FOOD PRODUCT - BAKING MIX

| | |
|---|---|
| Soy Protein | 30.00 |
| Starch-Resistant | 19.81 |
| Soy flour | 9.91 |
| Polydextrose | 6.60 |
| Milk Protein | 3.00 |
| Corn flour | 6.60 |
| Rice Flour | 6.60 |
| Soy Fiber | 6.60 |
| Oat Fiber | 6.60 |
| Double acting baking powder | 3.25 |
| Sodium Bicarbonate | |
| Sodium Acid pyrophosphate | |
| Moncalcium phosphate | |
| Sodium Aluminum phosphate | |
| Flavor | 0.66 |
| Salt | 0.33 |
| Supplements | 0.02 |
| Custom based on lifestyle | |
| | 100.00 |

FOOD PRODUCT - MUFFIN

| | |
|---|---|
| Wheat protein | 29.00 |
| Starch-Resistant | 15.00 |
| Soy flour | 5.00 |
| Polydextrose | 6.50 |
| Cane Sugar | 3.50 |
| Maltitol | 7.00 |
| Whey protein | 3.00 |
| Milk Protein | 3.00 |
| Wheat flour | 7.00 |
| Whole Eggs | 3.00 |
| Egg Yolks | 1.50 |
| Coconut Oil | 4.00 |
| Inulin-Fiber | 6.00 |
| Double acting baking powder | 5.39 |
| Sodium Bicarbonate | |
| Sodium Acid pyrophosphate | |
| Moncalcium | |
| Sodium Aluminum phosphate | |
| Flavor | 0.66 |
| Salt | 0.33 |
| Sucralose | 0.10 |
| Supplements | 0.02 |
| Custom based on lifestyle | |
| | 100.00 |

FOOD PRODUCT - PANCAKE

| | |
|---|---|
| Wheat protein | 22.00 |
| Soy protein | 11.06 |
| Starch-Resistant | 20.00 |
| Oat Fiber | 5.00 |
| Honey | 6.50 |
| Cane Sugar | 3.50 |
| Whey protein | 3.00 |
| Whole Milk | 3.00 |
| Wheat flour | 7.00 |
| Whole Eggs | 3.00 |
| Soy Oil | 4.00 |
| Inulin-Fiber | 7.00 |
| Sodium Bicarbonate | 1.90 |
| Moncalcium | 0.60 |
| Sodium Aluminum phosphate | 1.20 |
| Flavor | 0.68 |
| Xanthan | 0.20 |
| Salt-(Flour) | 0.34 |
| Supplements | 0.02 |
| Custom based on lifestyle | |
| | 100.00 |

The above examples are representative only and not meant to limit the scope of the present invention. As stated, various combinations are possible of the components taught herein in order to provide a food composition which is capable of serving as a substitute for traditional flour and sugar-based food compositions having a relatively high amount of such flour and sugars therein while still mimicking the organeolaptic properties of such traditional products.

In order to produce a food composition as taught herein, the first steps include providing a base of the type described above not primarily of flour and sugar and a supplement as described above. Both base and supplement are combined to form a composition which acts as a substitute for traditional food compositions in the manner defined herein. Preferred examples of combining the base and supplement include blending, milling and mixing. Still further, the food composition as blended, mixed or milled may then be heated (baked) to form a resulting baked good product such as a bread, biscuits, muffins, etc.

Thus there has been shown and described in detail food compositions which are highly nutritious and which can be made in the form of convention food products such as muffins, donuts, etc., as well as subjected to conventional further processing such as baking, mixing, blending, etc. These food products possess relatively high nutritional values, as evidenced by the above examples, and are thus considered healthy food choices for the consumer.

While there have been shown and described what are at present the preferred embodiments of the invention, it will be obvious to those skilled in the art that various changes and modifications may be made therein without departing from the scope of the invention as defined by the appended claims.

1. A food composition comprising:
a base not primarily of flour and sugar; and
a supplement, said food composition being a substitute for traditional flour and sugar-based food compositions and substantially mimicking the organeoleptic properties of said traditional flour and sugar-based food compositions.

2. The food composition of claim 1 wherein said food composition is a baking mix.

3. The food composition of claim 1 wherein said food composition is a baked good product.

4. The food composition of claim 3 wherein said baked good product is a bread product.

5. The food composition of claim 3 wherein said baked good product is selected from the group consisting of biscuits, muffins, doughnuts, cookies, pancakes, and waffles.

6. The food composition of claim 1 wherein said food composition is a dough material.

7. The food composition of claim 1 wherein said food composition is a cereal.

8. The food composition of claim 1 wherein said food composition is a pasta product.

9. The food composition of claim 1 wherein said base is selected from the group consisting of grain proteins, grain fibers, grain brans, grain starches, isolates and mixtures thereof.

10. The food composition of claim 1 wherein said base comprises milk or milk derivative proteins.

11. The food composition of claim 1 wherein said base comprises sugar or a sugar substitute.

12. The food composition of claim 1 wherein said base comprises fats.

13. The food composition of claim 1 wherein said base comprises at least one leavening system and at least one salt.

14. The food composition of claim 1 wherein said supplement is selected from the group consisting of vitamins, minerals, amino acids, nutraceuticals, special nutrients and mixtures thereof.

15. The food composition of claim 14 where in said supplement is a vitamin, said vitamin selected from the group consisting of Ascorbic Acid, Beta-carotene, Biotin, Choline, Folic Acid, Inositol, Niacin, Pantothenic Acid (Vitamin B5), Phylloquinone (Vitamin K), Pyridoxine (Vitamin B6), Riboflavin (Vitamin B2), Thiamin (Vitamin B1), Vitamin A, Vitamin B12, Vitamin D, Vitamin E and mixtures thereof.

16. The food composition of claim 14 wherein said supplement is a mineral, said mineral selected from the group consisting of Boron, Calcium, Chloride, Chromium, Chromium III, Copper, Fluoride, Iodine, Iron, Magnesium, Manganese, Molybdenum, Phosphorus, Potassium, Selenium, Silicon, Sodium, Sulfur, Vanadium, Zinc and mixtures thereof.

17. The food composition of claim 14 wherein said supplement is an amino acid, said amino acid selected from the group consisting of Alanine, Arginine, Aspartic Acid, Asparagine, Carnitine, Cysteine, Cystine, Glutamic Acid, Glutamine, Glutathione, Glycine, Histidine, Isoleucine, Leucine, Lysine, Methionine, Ornithine, Phenylalanine, Proline, Serine, Taurine, Threonine, Tryptophan, Tyrosine, Valine and mixtures thereof.

18. The food composition of claim 14 wherein said supplement is a nutraceutical, said nutraceutical selected from the group consisting of Aloe Vera (Aloe ferox, A. barbadensis), Artichoke, Asian Ginseng (Panax ginseng), Astragalus, Bee Pollen, Bilberry (Vaccinium myrtillus), Black Cohosh, Capsicum-Cayenne, Hot Pepper (Capsicum species), Cascara Sagrada (Rhamnus purshiana), Cat's Claw (Uncaria tomentosa), Chamomile (Matricaria recutita), Cranberry, Dandelion (Taraxacum officinale), Donq Quai (Angelica sinensis), Echinacea (Echinacea purpurea and related species), Evening Primrose Oil (Oenothera biennis), Feverfew (Tanacetum parthenium), Fructo-oligosaccharides, Garlic (Allium sativum), Ginger (Zingiber officinale), Ginkgo (Ginkgo biloba), Ginseng, Glucarate, Glucosamine, Goldenseal (Hydrastis canadensis), Gotu Kola (Centella Asiatica), Grape Seed Extract, Green Tea, Guarana (Paullinacupana), Hawthorne (Crataegus oxyacantha), Inulin, Isoflavones, Kava Kava (Piper methysticum), L-carnitine, Lecithin, Licorice (Glycyrrhiza glabra and G. uralensis), Lycopene, Milk Thistle (Silybum marianum), Mod. Citrus Peel, Nettles, Oligofructose, Omega-3s, Passiflora, Passion Flower (Passiflora incarnata), Pau d'Arco, (Tabebuia impetiginosa), Peppermint (Mentha piperita), Phospholipids, Polyphenol, Psyllium (Plantago ovata and P. Major), Pycnogenol, Queroetin D-llmonene, Reishi, Ribonucleic Acid, Royal Jelly, St. John's Wort (Hypericum perforatum), Saw Palmetto (Serenoa repens; Sabal serrulata), Schisandra, Soybean Isoflavones, Tumeric Valerian (Valeriana officinalis) and mixtures thereof.

19. The food composition of claim 14 wherein said supplement is a special nutrient, said special nutrient selected from the group consisting of Acetyl Glucosamine, Acetyl-L-Carnitine, Alpha-Ketoglutaric Acid, Alpha Lipoic Acid, Androstenedione, Arginine Pyroglutamate Arthred, Co-Enzyme Q-10, Creatine Monohydrate, DHEA (dehydroepiandrosterone), DMAE (dimethylaminoethanol), DMG (dimethylglycine), Gamma Oryzanol, Glucosamine Sulfate, Lutein, Melatonin, N-Acetyl Cysteine, PABA, Phosphatidylcholine, Pregnenolone, Pyruvate, Quercetin, Sano-Gastirl, Seriphos, Stabilium, Tricycline, Trifal and mixtures thereof.

20. A method of making a food composition comprising:
providing a base not primarily of flour and sugar;
providing a supplement; and
combining said base and supplement, said food composition being a substitute for traditional flour and sugar-based food compositions and substantially mimicking the organeoleptic properties of said traditional flour and sugar-based food compositions.

21. The method of claim 19 wherein said combining of said base and said supplement is accomplished by blending, milling or mixing.

22. The method of claim 19 further including baking said food composition combined by said blending, milling or mixing.

23. A base food product not primarily of flour and sugar adapted for being combined with a supplement to form a food composition, said food composition adapted for substituting for traditional flour and sugar-based food compositions and substantially mimicking the organeoleptic properties of said traditional flour and sugar-based food compositions.

24. The invention of claim 22 wherein said base is selected from the group consisting of grain proteins, grain fibers, grain brans, grain starches and mixtures thereof.

25. The invention of claim 22 wherein said base comprises milk or milk derivative proteins.

26. The invention of claim 22 wherein said base comprises sugar or sugar substitute.

27. The invention of claim 22 wherein said base comprises at least one leavening system and at least one salt.
